(19) United States
(12) Patent Application Publication
(10) Pub. No.: US 2005/0276886 A1
(43) Pub. Date: Dec. 15, 2005

(54) Micro wave ice cream

(76) Inventor: Bobby Joe, Jasper, AR (US)

Correspondence Address: Bobby Joe Lambert, HC 72, Box 34, Jasper, AR, 72641, US

(21) Appl. No.: 10/756,908

(22) Filed: Jun. 12, 2004

(51) Int. Cl. C12C 1/027

(52) U.S. Cl. 426/234

(57) ABSTRACT

Micro Wave Ice Cream is a process by which you can make a very good ice cream. By placing ice cream in single serving cartons that are microwavable in a liquid form. This eliminates the need for air to be mixed into the product after cartons are liquid filled they are placed in cold storage for freezing. After freezing consumers can simply place carton in microwave for 40 seconds. Ice cream is now ready to eat.

Micro Wave Ice Cream mix is packaged in single serving containers in liquid form. These containers are then placed in cold storage to be frozen.

To prepare ice cream for consumption place carton in microwave for 40 seconds. This process changes the hard frozen block ice cream mix into a soft eatable mixture very similar to homemade hand cranked ice cream.

### CROSS REFERENCE TO RELATED APPLICATIONS

Application Ser. No. 10/756,908

### STATEMENT REGARDING FEDERALLY SPONSORED RESEARCH OR DEVELOPMENT

NOT APPLICABLE

### REFERENCE TO SEQUENCE LISTING, A TABLE OR A COMPUTER PROGRAM LISTING

### COMPACT DISC APPENDIX

NOT APPLICABLE

### BACKGROUND OF THE INVENTION

This endeavor is to change the manufacturing of a food product, “ice cream” in particular. The industry standard of making ice cream is to take a liquid ice cream mix place it in a computerized freezer where air is pumped into the mix while it is being frozen to a consistency similar to mayonnaise. This allows the factory to package the product prior to placing it in cold storage without a blending of 50% air and ice cream mix the industry standard ice cream would be very much like a block of ice. In order to retain the air into the ice cream the product must be frozen prior to packaging.

### BRIEF SUMMARY OF INVENTION

The idea of Micro Wave Ice Cream is to minimize manufacturing time and eliminate the need for expensive electric computerized freezers to pre-freeze the product before packaging. This process would also eliminate consumers from purchasing a gallon of ice cream only to find out they just bought a half gallon of air. Micro Wave Ice Cream is placed into single serving then placed into cold storage for freezing. The consumer simply places carton in micro wave for 40 seconds and eat.

### BREIF DESCRIPTION OF THE SEVERAL VIEWS OF THE DRAWING

NOT APPLICABLE

### DETAILED DESCRIPTION OF THE INVENTION

Micro Wave Ice Cream is a concept to minimize the manufacturing of ice cream. This product is placed in single serving carton as a premixed liquid with no air, and then placed in cold storage to freeze the product. To prepare for consumption simply place carton in microwave for 40 seconds and enjoy a special texture of ice cream reminiscent of the days of homemade hand cranked ice cream.

1. I claim Micro Wave Ice Cream need no pre-freezing before packaging.

2. I claim Micro Wave Ice Cream does not use air in the product to make it eatable.

3. I claim Micro Wave Ice Cream have its own texture and consistency of hand cranked home made ice cream.
